(19) United States
(12) Patent Application Publication
(10) Pub. No.: US 2005/0250439 A1
(43) Pub. Date: Nov. 10, 2005

(54) Book radio system

(76) Inventor: Garthen Leslie, Columbia, MD (US)

Correspondence Address: LITMAN LAW OFFICES, LTD, PO BOX 15035, CRYSTAL CITY STATION, ARLINGTON, VA, 22215, US

(21) Appl. No.: 11/049,862

(22) Filed: Feb. 4, 2005

Related U.S. Application Data
(60) Provisional application No. 60/568,236, filed on May 6, 2004.

(51) Int. Cl. H04B 7/15

(52) U.S. Cl. 455/11.1

(57) ABSTRACT

A BOOK RADIO system includes a BOOK RADIO broadcast base station and at least one BOOK RADIO receiving/playing device configured to communicatively interconnect with the BOOK RADIO broadcast base station. The BOOK RADIO system records, serializes, digitizes, stores, and provides BOOK RADIO data from said BOOK RADIO broadcast base station to the at least one BOOK RADIO receiving/playing device when the BOOK RADIO receiving/playing device(s) are communicatively interconnected with the BOOK RADIO broadcast base station. The BOOK RADIO system is configured to provide a user of the BOOK RADIO receiving/playing device(s) with a variety of options including a Current Book option, a Previous Book Option, a New Book option, an End Book option, an Other Material option, a Book Series option, a Book Reviews option, and a System Exit option when the BOOK RADIO receiving/playing device(s) are communicatively interconnected with the BOOK RADIO broadcast base station.

### CROSS-REFERENCE TO RELATED APPLICATION

This application claims the benefit of U.S. Provisional Patent Application Ser. No. 60/568,236, filed May 6, 2004, which is incorporated herein by reference.

### BACKGROUND OF THE INVENTION

1. Field of the Invention

The present invention relates generally to pre-read books and, more particularly, to a BOOK RADIO system.

2. Description of Related Art

Electronic distribution of books and other literary works can now be accomplished via cassette tapes, compact discs (CDs), and/or the Internet. The problems and disadvantages with books on cassette tapes, electronic books (ebooks), books on CD, and books on the Internet include:
(1) Selection—complete titles must be known.
(2) Ordering—requires a home address, credit card number, phone number, and/or email address to place an order; ebook orders require ebooks to be downloaded and the purchase of ebook reading software.
(3) Payment—requires use of a credit card and address information of a user for each book order.
(4) Storing—storage is required to carry and protect the media.
(5) Media selection—the user is required to select the media which might be different for the home, car, and portable devices.
(6) Portability—the user must remember to carry the tapes or CDs from home to car to portable devices, and from portable devices to car to home, or any other combination; books on the Internet are not portable; ebook access requires a device loaded with ebook reading software.
(7) Use and manipulation—the user is required to remember which tape and which side of the tape or which CD and which track is being played if the media is ever removed from the player.
(8) Restart—the user must remember where he/she ended the last listening session; restart requires use of fast-forward and rewind for cassette tapes or track surfing on CDs.
(9) Media protection—tapes are subject to damage from temperature, dust, and oils from hands and fingers; CDs are subject to breakage and surface scratches.
(10) Cost—each new book must be purchased on tapes and/or CDs; for ebooks and books on the Internet, the user needs to purchase ebook reading software.
Safety—tapes and CDs must be removed and replaced once the end of a book or the end of a CD is reached, which increases the risk of accidents while driving.
Tracking—currently there is no way to have a book or other material electronically follow an individual from home to a vehicle to a plane, to a ship, to any other desired location, and back home.

The related art is represented by the following references of interest.

U.S. Patent Application Publication No. 2001/0037375 A1 and U.S. Pat. No. 6,253,237 B1, published Nov. 1, 2001 and issued Jun. 26, 2001, respectively, for Guy A. Story et al., describe a method and apparatus for personalized time-shifted programming. The Story et al. application and patent do not suggest a BOOK RADIO system according to the claimed invention.

U.S. Patent Application Publication No. 2001/0042109 A1 and U.S. Pat. No. 6,389,463 B2, published Nov. 15, 2001 and issued May 14, 2002, respectively, for Mark T. Bolas et al., describe a system for receiving and playing back audio content from an Internet audio content provider capable of streaming audio to Internet users. The Bolas et al. application and patent do not suggest a BOOK RADIO system according to the claimed invention.

U.S. Patent Application Publication No. 2002/0046315 A1, published Apr. 18, 2002 for Edward C. Miller et al., describes a system for the control of display data in a hand-held portable media device. The Miller et al. application does not suggest a BOOK RADIO system according to the claimed invention.

U.S. Pat. No. 4,455,651, issued Jun. 19, 1984 to Paul Baran, describes an earth satellite communications system for transmitting data from a plurality of users through a repeating geostationary satellite to a plurality of receiving earth stations. The Baran patent does not suggest a BOOK RADIO system according to the claimed invention.

U.S. Pat. No. 4,788,675, issued Nov. 29, 1988 to Markley L. Jones et al., describes a music delivery arrangement permitting a subscriber to select from among a plurality of available music selections, particular selections that he wishes to hear at any time. The Jones et al. patent does not suggest a BOOK RADIO system according to the claimed invention.

U.S. Pat. No. 5,440,336, issued Aug. 8, 1995 to William R. Buhro et al., describes a system and method for storing and forwarding audio/video signals on demand. The Buhro et al. patent does not suggest a BOOK RADIO system according to the claimed invention.

U.S. Pat. Nos. 5,557,541 and 5,572,442, issued on Sep. 17, 1996 and Nov. 5, 1996, respectively, to Nathan Schulhof et al., describe a distribution system for audio program materials. The Schulhof et al. '541 and '442 patents do not suggest a BOOK RADIO system according to the claimed invention.

U.S. Pat. No. 5,734,823, issued on Mar. 31, 1998 for Michael M. Saigh et al., describes an information distribution system. The Saigh et al. patent does not suggest a BOOK RADIO system according to the claimed invention.

U.S. Pat. No. 5,758,088, issued on May 26, 1998 t David L. Bezaire et al., describes a system for transmitting messages between an installed network and a wireless device. The Bezaire et al. patent does not suggest a BOOK RADIO system according to the claimed invention.

U.S. Pat. No. 5,758,293, issued on May 26, 1998 to James R. Frasier, describes a subscriber unit for wirelessly retrieving information from an information source. The Frasier patent does not suggest a BOOK RADIO system according to the claimed invention.

U.S. Pat. No. 5,918,213, issued on Jun. 29, 1999 to Warren E. Bernard et al., describes a system and method for automated remote previewing and purchasing of music, video, software, and other multimedia products. The Bernard et al. patent does not suggest a BOOK RADIO system according to the claimed invention.

U.S. Pat. No. 5,973,722, issued Oct. 26, 1999 to Bruce M. Wakai et al., describes an audio distribution system for distributing audio content to one or more passengers on an aircraft. The Wakai et al. patent does not suggest a BOOK RADIO system according to the claimed invention.

U.S. Pat. No. 6,014,569, issued Jan. 11, 2000 to Joshua Bottum, describes a mobile interactive radio for wireless communication with a wireless system using asynchronous audio program data. The Bottum patent does not suggest a BOOK RADIO system according to the claimed invention.

U.S. Pat. No. 6,223,291 B1, issued Apr. 24, 2001 to Larry C. Puhl et al., describes a wireless electronic commerce system. The Puhl et al. patent does not suggest a BOOK RADIO system according to the claimed invention.

U.S. Pat. No. 6,300,880 B1, issued Oct. 9, 2001 to Eran Sitnik, describes a multichannel switched communication system having a plurality of communication channels, with a plurality of information records stored in a database relating to a plurality of identified objects. The Sitnik patent does not suggest a BOOK RADIO system according to the claimed invention.

World International Patent Organization (WIPO) Application Publication No. 98/34184, published Aug. 6, 1998, describes an electronic book that permits visualization oft significant information volumes displayed in the form of graphic symbols, such information being drawn from a medium directly connected with the electronic book, as well as transmission-reception of information on the global communication channels or the wireless communication channel by using, by means of infrared transmission, the protocols for cellular, radiopaging, modem, facsimile, or satellite communication, and can also be used as an individual means for reading books, looking up charts and other information, and as a means to receive audio information. The WIPO '184 application does not suggest a BOOK RADIO system according to the claimed invention.

WIPO Application Publication No. 99/49615, published Sep. 30, 1999, describes an information distribution system. The WIPO '615 application does not suggest a BOOK RADIO system according to the claimed invention.

None of the above inventions and patents, taken either singly or in combination, is seen to describe the instant invention as claimed. Thus a BOOK RADIO system solving the aforementioned problems is desired.

### SUMMARY OF THE INVENTION

The present invention is a BOOK RADIO system. The BOOK RADIO system includes a BOOK RADIO broadcast base station and at least one BOOK RADIO receiving/playing device configured to communicatively interconnect with the BOOK RADIO broadcast base station. The BOOK RADIO system records, serializes, digitizes, stores, and provides BOOK RADIO data from said BOOK RADIO broadcast base station to the at least one BOOK RADIO receiving/playing device when the BOOK RADIO receiving/playing device(s) are communicatively interconnected with the BOOK RADIO broadcast base station. The BOOK RADIO system is configured to provide a user of the BOOK RADIO receiving/playing device(s) with a variety of options including a Current Book option, a Previous Book Option, a New Book option, an End Book option, an Other Material option, a Book Series option, a Book Reviews option, and a System Exit option when the BOOK RADIO receiving/playing device(s) are communicatively interconnected with the BOOK RADIO broadcast base station.

The BOOK RADIO system provides an easy to use mechanism for selecting and listening to pre-read and recorded books, and other pre-read material, such as newspapers, magazine, and speeches, or the like, via BOOK RADIO receiving/listening devices in a car, home, or any place during anytime.

Selected books may be read, recorded, serialized and digitized using any efficient digitizing methods, hardware and software available. The digitized data (pre-read book and other selected information) may be stored and serialized for later access. When requested, the digitized and stored book may be transmitted (up linked) to a satellite and broadcast to an authorized user. A BOOK RADIO management system (hardware and software) keeps track of which books are requested and who requested them. The authorized user, using BOOK RADIO receiving/playing devices or a BOOK RADIO website, may make requests for books and other pre-read material, and have the pre-read book delivered to them in real-time with digital satellite quality. Additional information about available books, new BOOK RADIO features, users' reading history, book reviews, book awards, book samples, author information, reader information, book popularity, and/or volume published may be provided.

Accordingly, it is a principal aspect of the invention to provide a BOOK RADIO system including a BOOK RADIO broadcast base station, and at least one BOOK RADIO receiving/playing device configured to communicatively interconnect with the BOOK RADIO broadcast base station, wherein the BOOK RADIO system records, serializes, digitizes, stores, and provides BOOK RADIO data from said BOOK RADIO broadcast base station to the at least one BOOK RADIO receiving/playing device when the at least one BOOK RADIO receiving/playing device is communicatively interconnected with the BOOK RADIO broadcast base station.

It is an aspect of the invention to provide improved elements and arrangements thereof in a BOOK RADIO system for the purposes described which is inexpensive, dependable, and fully effective in accomplishing its intended purpose.

These and other aspects of the present invention will become readily apparent upon further review of the following specification and drawings.

### BRIEF DESCRIPTION OF THE DRAWINGS

FIG. 1 is a block diagram of a BOOK RADIO system according to the present invention.

FIG. 2 is a block diagram of a BOOK RADIO base station according to the present invention.

FIG. 3A is a front view of an example of a BOOK RADIO receiving/playing device according to the present invention.

FIG. 3B is a block diagram of a BOOK RADIO receiving/playing device according to the present invention.

FIG. 4A is a flow chart of a recording and storing process of a BOOK RADIO system according to the present invention.

FIG. 4B is a flow chart of a user/device authentication process of a BOOK RADIO system according to the present invention.

FIG. 5A is one part of a flow chart of a user request option E process of a BOOK RADIO system according to the present invention.

FIG. 5B is another part of a flow chart of a user request option E process of a BOOK RADIO system according to the present invention.

FIG. 6A is a flow chart of a user request option G process of a BOOK RADIO system according to the present invention.

FIG. 6B is a flow chart of a user request option H process of a BOOK RADIO system according to the present invention.

FIG. 6C is a flow chart of a user request option I process of a BOOK RADIO system according to the present invention.

FIG. 6D is a flow chart of a user request option J process of a BOOK RADIO system according to the present invention.

FIG. 7A is a flow chart of a user request option M process of a BOOK RADIO system according to the present invention.

FIG. 7B is a flow chart of a user request option N process of a BOOK RADIO system according to the present invention.

FIG. 7C is a flow chart of a user request option O process of a BOOK RADIO system according to the present invention.

FIG. 8 is a diagram showing how a BOOK RADIO system actively tracks a user of the BOOK RADIO system according to the present invention.

FIG. 9 is a BOOK RADIO INVENTORY DATABASE file layout of a BOOK RADIO system according to the present invention.

FIG. 10 is a BOOK RADIO TRACKING SYSTEM DATABASE file layout of a BOOK RADIO system according to the present invention.

FIG. 11 is a BOOK RADIO ACTIVE PLAY LIST DATABASE file layout of a BOOK RADIO system according to the present invention.

FIG. 12 is a BOOK RADIO AUTHOR INFORMATION DATABASE file layout of a BOOK RADIO system according to the present invention.

FIG. 13 is a BOOK RADIO ACTIVE USER INFORMATION DATABASE file layout of a BOOK RADIO system according to the present invention.

FIG. 14 is a BOOK RADIO DORMANT USER DATABASE file layout of a BOOK RADIO system according to the present invention.

Similar reference characters denote corresponding features consistently throughout the attached drawings.

### DETAILED DESCRIPTION OF THE PREFERRED EMBODIMENTS

The present invention is a BOOK RADIO system. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

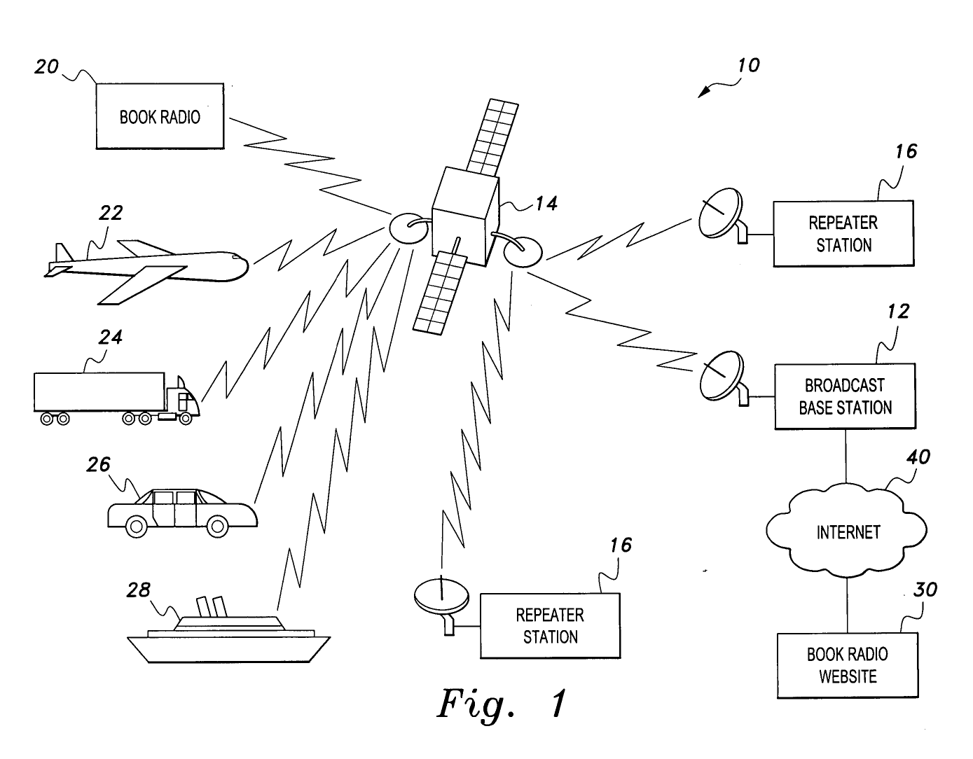

Referring to the drawings, FIG. 1 illustrates a BOOK RADIO system 10 configured for recording, serializing, digitizing, storing, and/or uplinking to satellites, and transmitting book data content and other pre-read material to users having a properly configured BOOK RADIO receiving/playing device 20. BOOK RADIO system 10 includes BOOK RADIO broadcast base station 12, satellite 14, repeater stations 16, and any number of users with a BOOK RADIO receiving/playing device 20 who may be mobile and traveling in planes 22, trucks 24, cars 26, boats 28, etc.

BOOK RADIO broadcast base station 12 is coupled through an antenna at an appropriate frequency through which transmissions are made to uplink BOOK RADIO data content and other pre-read material to satellite 14. Repeater stations 16 are coupled through antennas via an appropriate communications channel to receive and transmit transmission signals from satellite 14. BOOK RADIO system 10 may include any number of satellites 14 and repeater stations 16. Mobile users with BOOK RADIO receiving/playing devices 20 are coupled via an appropriate communications channel to receive transmission signals from satellite 14 at an appropriate mobile communications frequency. BOOK RADIO system 10 may also include a BOOK RADIO website 30 operated by an appropriate server to provide BOOK RADIO information, to enable non-subscribed users to subscribe for BOOK RADIO services, and/or to enable subscribed users to request books, unsubscribe, or the like, over the Internet.

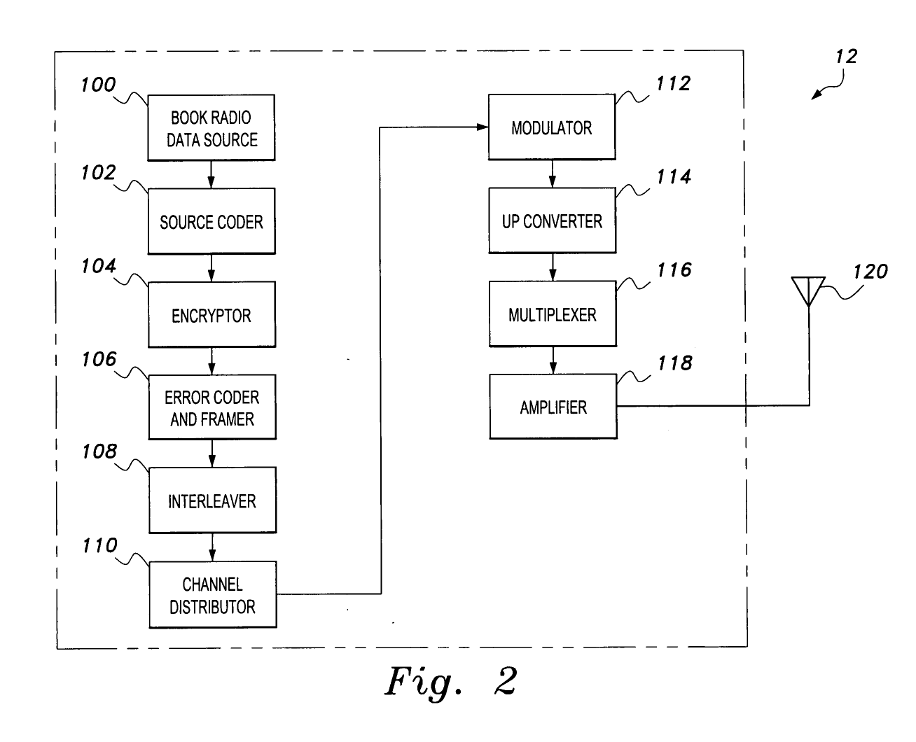

A block diagram of an example of a BOOK RADIO broadcast base station 12 is shown in FIG. 2. BOOK RADIO broadcast base station 12 includes BOOK RADIO data source 100, source coder 102, encryptor 104, error coder and framer 106, interleaver 108, channel distributor 110, modulator 112, up converter 114, multiplexer 116, amplifier 118, and antenna 120. The elements are well known in the art. These elements are interconnected t processing capabilities of a computer system which includes BOOK RADIO management software. The BOOK RADIO management software causes processor(s) of the computer system to access material regarding books or other material that is stored in BOOK RADIO data source 100, prepare material for uplinking to satellite 14, and effect uplinking to satellite 14. Communication, requests, and instructions to/from users are controlled via the BOOK RADIO management software.

Repeater stations 16 assist in the continuous transmission of book data or other material uplinked to satellite 14 from BOOK RADIO broadcast base station 12 when BOOK RADIO receiving/playing device(s) 20 are in a densely populated area or an area with significant obstruction of satellite transmission. Repeater stations 16 may be placed in and around large cities and other areas where tall structures obstruct the quality of satellite transmission.

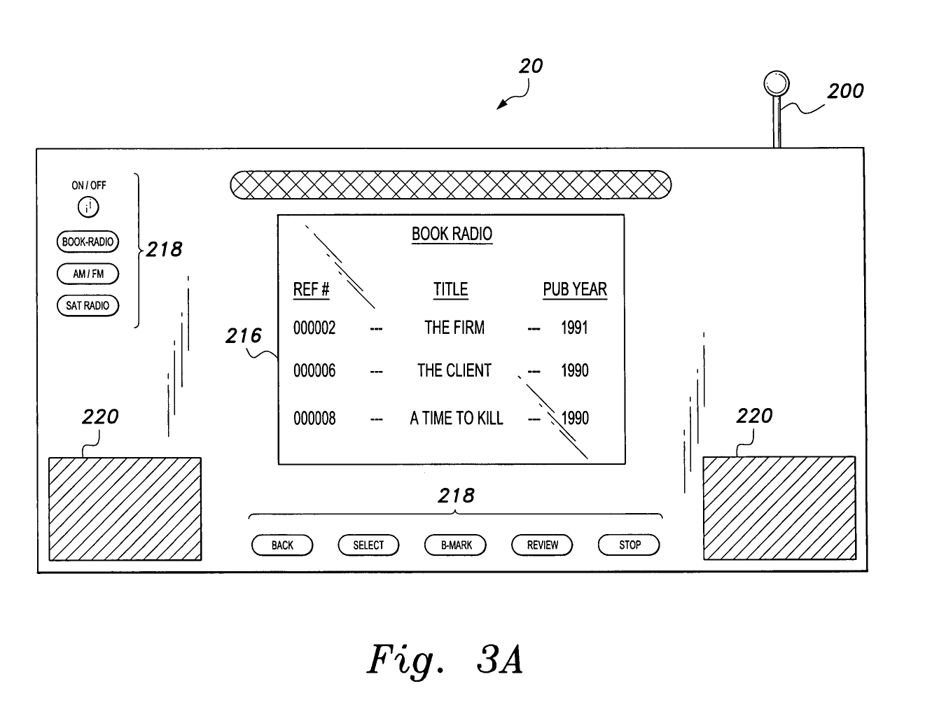

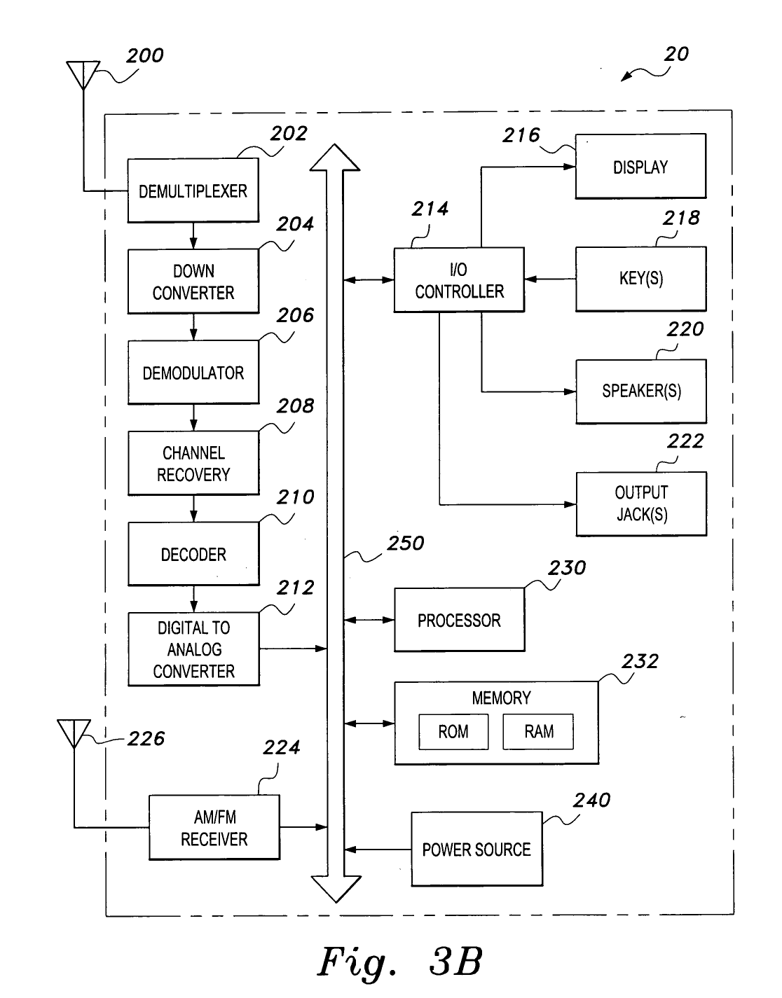

FIGS. 3A and 3B illustrate an example of a BOOK RADIO receiving/playing device 20. BOOK RADIO receiving/playing device 20 is configured to provide portability and user friendliness. BOOK RADIO receiving/playing device 20 includes a housing that may be made of any desired durable material, such as plastic, metal, or the like, according to the desires of the user. BOOK RADIO receiving/playing device 20 may include demultiplexer 202, down converter 204, demodulator 206, channel recovery element 208, decoder 210, digital to analog converter 212, input/output controller 214, display 216, key(s) 218, speaker(s) 220, output jack(s) 222, processor 230, memory 232, and power source 240, which are all communicatively interconnected via communication bus 250. BOOK RADIO receiving/playing device 20 may also include an AM/FM radio receiver 224 to receive AM/FM broadcast radio. These element are all well known in the art and may be used according to the desires of the user.

As shown, keys or buttons 218, any number of which may be used, may include an ON/OFF button for turning BOOK RADIO receiving/playing device 20 on and off, a BOOK RADIO button for selecting a particular BOOK RADIO menu screen, an AM/FM button for selecting AM or FM broadcast radio, a SATELLITE RADIO button for selecting satellite radio, a START button for starting the BOOK RADIO system 10 or a book selection process, a SELECT button for selecting a book selection process to select a particular book or other material, a B-MARK button to designate a book mark at a predetermined point in a book or other material, and a STOP button to stop a book or other material at a current point. Any other buttons may be included as desired. Display 216 may be any desired display, such as a liquid crystal display or the like, with various data display formats. Speakers 220 enable users to hear audible output of books or other material that have been recorded and that are transmitted by BOOK RADIO broadcast base station 12, or conventional AM/FM broadcast radio.

Selected books and other printed material are read by designated readers and recorded in an acoustically suitable chamber or studio. Designated readers are subjectively determined based on the best fit with the book or other subject material, and/or the speaking characters within the book or other subject material. Additional consideration may be given for voice quality, diction, ethnicity, age, gender, and/or any other particular characteristics that may be associated with the material content. Multiple readers may be utilized as desired. Predetermined languages, such as English, French, Spanish, German, or the like, may be implemented as desired.

A reader may record his/her biographical information and also that of the author of the selected book or other printed material. The reader may also record selected book reviews, book awards, book rankings from various lists, book editions, and/or any book forward information that may be desired. Similar information from other printed material may also be recorded. The reader records each chapter number before it is read. This information is considered part of BOOK AND DOCUMENT LEAD IN information and may be skipped according to the desires of a user. The reader may record the number of each chapter and the title of articles or topics for other printed materials before the actual reading begins. This information may be used in supporting restarts of the particular reading selection. The recording process employs recording and compression methodology utilizing available technology. Any suitable recording media may be employed.

Chapter, page, and line benchmarks may be placed in the data for specific chapter references and for supporting desired book reading restarts. Each recorded book may be put through a quality confirmation process to ensure the quality and marketability of the recording. Recorded books are the digitized (converted into a suitable format for transmission) and serialized (given a serial number for future reference). If recorded book does not pass a quality confirmation process the recording may be repeated. This process may continue until the book recording and all other recorded data is of desired quality.

Recorded books are digitally stored in a BOOK RADIO date source 100. Users may be notified of newly recorded books via email or BOOK RADIO website 30 that may include predetermined information regarding the newly recorded books, such as associated titles, serial numbers, author information, or the like. An inventory index file is updated for enabling book searches.

After book data and/or other recorded material has been uplinked to satellite 14, the data is transmitted to planes 22, trucks 24, cars 26, boats 28, or any location where a user with a BOOK RADIO receiving/playing device 20 is located. BOOK RADIO receiving/playing device 20 interfaces with the BOOK RADIO management software of BOOK RADIO system 10.

Upon activation, a particular BOOK RADIO receiving/playing device 20 may communicate with the BOOK RADIO management software to authenticate the user of the particular BOOK RADIO receiving/playing device 20. When a user subscribes for BOOK RADIO service they provide a predetermined BOOK RADIO device 20 authentication number or identifier, such as a serial number, unique device identifier, or the like. BOOK RADIO receiving/playing device 20 includes BOOK RADIO recorder/playback device software stored in the memory of BOOK RADIO receiving/playing device 20. The BOOK RADIO recorder/playback device software causes processor 230 to relay the authentication number or identifier to the BOOK RADIO management software. Other information may also be provided by the user, such as a personal identification number, a social security number, or the like, to ensure that the individual using BOOK RADIO receiving/playing device 20 is the authorized user.

The BOOK RADIO management software generates a unique identifier for the user by processing user entered information with a predetermined algorithm. The processed user information is stored and associated with the particular user in BOOK RADIO data source 100. The stored identifier is checked to identify the user as a legitimate user each time the user of BOOK RADIO receiver/playing device 20 tries to access BOOK RADIO system 10. The integrity of the user's stored identifier is protected because the predetermined algorithm generates the same user identifier for the particular combination of user information provided. Once a user is authenticated the user may access BOOK RADIO system 10 and proceed with any available function for books, or access other recorded material. A user who is not authenticated after a predetermined number of authentication attempts, such as three or the like, is provided with a non-authentication message, an email is sent to the BOOK RADIO receiving/playing device 20, the user's email address, and/or the unauthenticated user is given a phone number of the authentication center to call for resolution. Problem resolution may be handled through BOOK RADIO website 30.

BOOK RADIO receiving/playing device 20 enables users to make requests using the BOOK RADIO management software for services. When a BOOK RADIO receiving/playing device 20 is properly activated, the user is presented with a variety of options to choose from when requesting services using the BOOK RADIO management software. The user may also be asked to select a desired language for listening. The options include a Current Book option, a Previous Book option, a New Book option, an End Book option, an Other Material option, a Book Series option, a Book Reviews option, and a System Exit option.

The Current Book option is used when a user is requesting to continue listening to the most current book they selected. If the Current Book option is selected the user will be given a variety of additional sub options for selecting a continuation point. These sub options include a Book Beginning sub option, a Chapter Number sub option, a Page Number sub option, a Bookmark sub option, and an End Book sub option.

The Book Beginning sub option of the Current Book option starts a selected book at the beginning of the book. The Chapter Number sub option of the Current Book option starts a selected book at a chapter number indicated by the user. The Page Number sub option of the Current Book option starts a selected book at a page designated by the user. The Bookmark sub option of the Current Book option starts a selected book at a digital bookmark generated when the user suspends a previous listening session, or if power is lost to the BOOK RADIO receiving/playing device 20. If there is no Bookmark or other services. When a BOOK RADIO receiving/playing device 20 is properly activated, the user is presented with a variety of options to choose from when requesting services using the BOOK RADIO management software. The user may also be asked to select a desired language for listening. The options include a Current Book option, a Previous Book option, a New Book option, an End Book option, an Other Book Material option, a Book Series option, a Book Reviews option, and a System Exit option.

The Current Book option is used when a user is requesting to continue listening to the most current book they selected. If the Current Book option is selected the user will be given a variety of additional sub options for selecting a continuation point. These sub options include a Book Beginning sub option, a Chapter Number sub option, a Page Number sub option, a Bookmark sub option, and an End Book sub option.

The Book Beginning sub option of the Current Book option starts a selected book at the beginning of the book. The Chapter Number sub option of the Current Book option starts a selected book at a chapter number indicated by the user. The Page Number sub option of the Current Book option starts a selected book at a page designated by the user. The Bookmark sub option of the Current Book option starts a selected book at a digital bookmark generated when the user suspends a previous listening session, or if power is lost to the BOOK RADIO receiving/playing device 20. If there is no Bookmark or other sub option selection, the bookmark will be set at the beginning of the book. The End Book sub option of the Current Book option enables a user to gracefully end transmission of the selected book by having the user designate a particular point in the book via a bookmark, and to return the user to the selection menu.

The Previous Book option is used when a user is requesting to receive the book last accessed by the user prior to the current book. If the Previous Book option is selected the user will be given a variety of sub options for accessing the previous book selected by the user. These sub options include Book Beginning sub option, a Chapter Number sub option, a Page Number sub option, and a Bookmark sub option.

The Book Beginning sub option of the Previous Book option starts a selected book at the beginning of the book. The Chapter Number sub option of the Previous Book option starts selected book at a chapter number indicated by the user. The Page Number sub option of the Previous Book option starts a selected book at a page designated by the user. The Bookmark sub option of the Previous Book option starts a selected book at a digital bookmark generated when the user suspends a previous listening session, or if power is lost to the BOOK RADIO receiving/playing device 20. If there is no Bookmark or other sub option selection, the bookmark will be set at the beginning of the book.

The New Book option is used when a user requests to receive a new book. A predetermined number of books may be active for a particular user at any one time, such as two or the like. The active book limit for a particular user may be adjusted as desired. The number of active books associated with the user is checked to see if a new request will exceed the active book limit of the user. If the user's request will not exceed the active book limit of the user and the book is not currently active by the user, the user is presented with a variety of sub options. These sub options include a Book Reference Number sub option, a Book Title sub option, a Book Author sub option, an End Book sub option, and a Book Category sub option.

The Book Reference Number sub option of the New Book option enables a user to enter a reference number for a particular book, and to have BOOK RADIO system 10 retrieve and present to the user the book associated with the reference number. If the reference number is valid the user may skip introduction data and proceed to any start option. A default may be set to a predetermined chapter, such as chapter one or the like. If the reference number is invalid the user may be so notified and asked to enter a valid reference number.

The Book Title sub option of the New Book option enables a user to enter the title of a particular book, and to have BOOK RADIO system 10 retrieve and present to the user the book associated with particular book title entered by the user. BOOK RADIO system 10 may assist the user by showing books with titles that have the title text matching or closely matching the title text being typed by the user.

The Book Author sub option of the New Book option enables a user to enter the name of an author, and to have BOOK RADIO system 10 retrieve and present to the user a predetermined number of books written and/or associated with the name entered by the user. The books written by and/or associated with the particular author may be presented in various sorted orders (date published, alphabetical, etc.).

The End Book sub option of the New Book option enables a user to gracefully end transmission of a selected book by having the user designate a particular point in the book via a bookmark, and to return the user to the selection menu.

The Book Category sub option of the New Book option enables a user to enter a particular subject category, such as drama, mystery, sports, history, biography, or the like, and to have BOOK RADIO system 10 retrieve and present a predetermined number of books associated with the particular category entered by the user. If no category is entered by the user, the user may be presented with a list of available book categories from which to select.

The Other Material option enables a user to obtain a list of available material categories in alphabetical order with a count of the number of items in each category. The user may select a category and select the material within that category for access.

The Book Series option enables a user to select from a predefined series or to build his/her own series of books. For example, the user may want to access all the John Grisham books, all the Harry Potter books, the first book from four different authors, or the like. If the requested book is currently active the request may be treated as a previous book request.

The Book Reviews option enables a user to obtain one or more reviews by prominent and recognizable critics, newspapers, and any other desired literary reviewing organizations.

The System Exit option enables a user to exit the BOOK RADIO system 10 completely. The system 10 can record appropriate activity for the listening session, update appropriate files and databases, and return to a neutral state.

Simultaneously with the presentation of the main options (Current Book, Previous Book, New Book, End Book, Other Material, Book Series, Book Reviews, and System Exit), a BOOK RADIO ACCESS INFORMATION DATABASE of the user may be updated. Once a user makes a selection the BOOK RADIO management system extracts the digitized and stored book or other material, initiates an uplink process to transmit the book data or other material to satellite 14, and initiates transmission to the authenticated BOOK RADIO receiving/playing device 20 of the user. The user may designate, via BOOK RADIO website 30, that a selected book or other material be available to plural authenticated BOOK RADIO receiving/playing devices 20 of the user.

BOOK RADIO receiving/playing device 20 may also be configured for voice recognition to enable users to vocally activate various options on BOOK RADIO receiving/playing devices 20. This provides convenience of use and enables physically impaired individuals to access and utilize BOOK RADIO system 10. This also adds an element of increased safety for drivers of vehicles, when the driver is either carrying or has a BOOK RADIO receiving/playing device 20 or when the vehicle is equipped with a BOOK RADIO receiving/playing device 20.

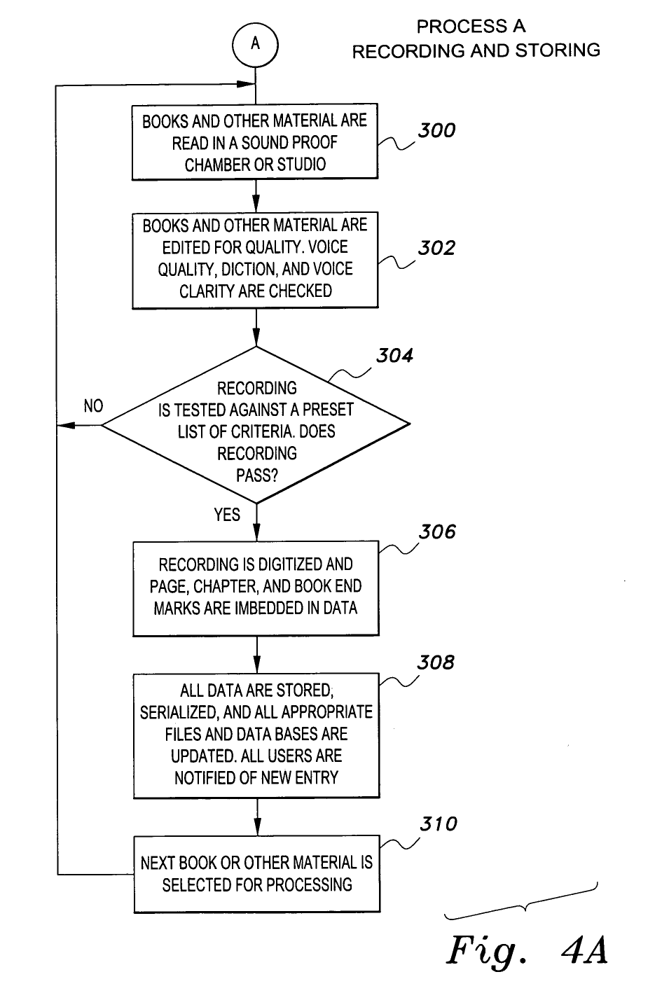

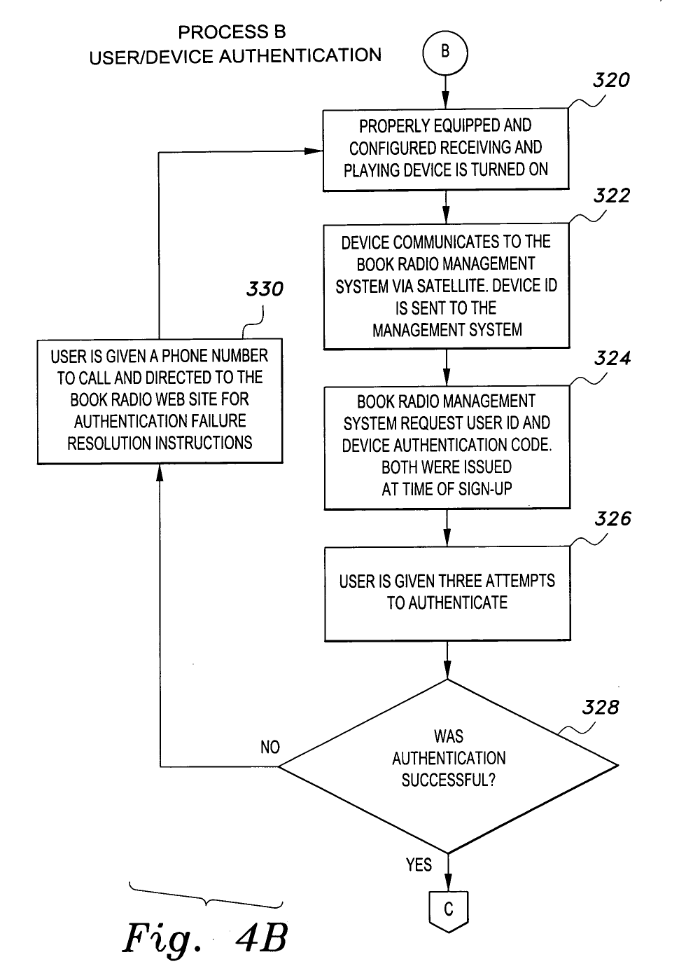

FIG. 4A shows a flow chart of a recording and storing process, referred to as process A, of BOOK RADIO system 10. In process A, books and other material are read in a sound proof chamber or studio 300. Books and other material are then edited for quality 302. Voice quality, diction, voice clarity, or the like, may be checked. A recording of a book or other material is then tested against a preset list of criteria and a determination is made as to whether the recording passes the test 304. If the recording does not pass the test the book or other material are reprocessed through steps 300 and 302 again. If the recording does pass the test the recording is digitized and the page, chapter, and book end marks are imbedded in the data 306. Data of the recording are stored, serialized, appropriate files and databases are updated, and users are notified of a new entry in BOOK RADIO system 10. Finally, process A waits until another book or other material is selected for processing 310.

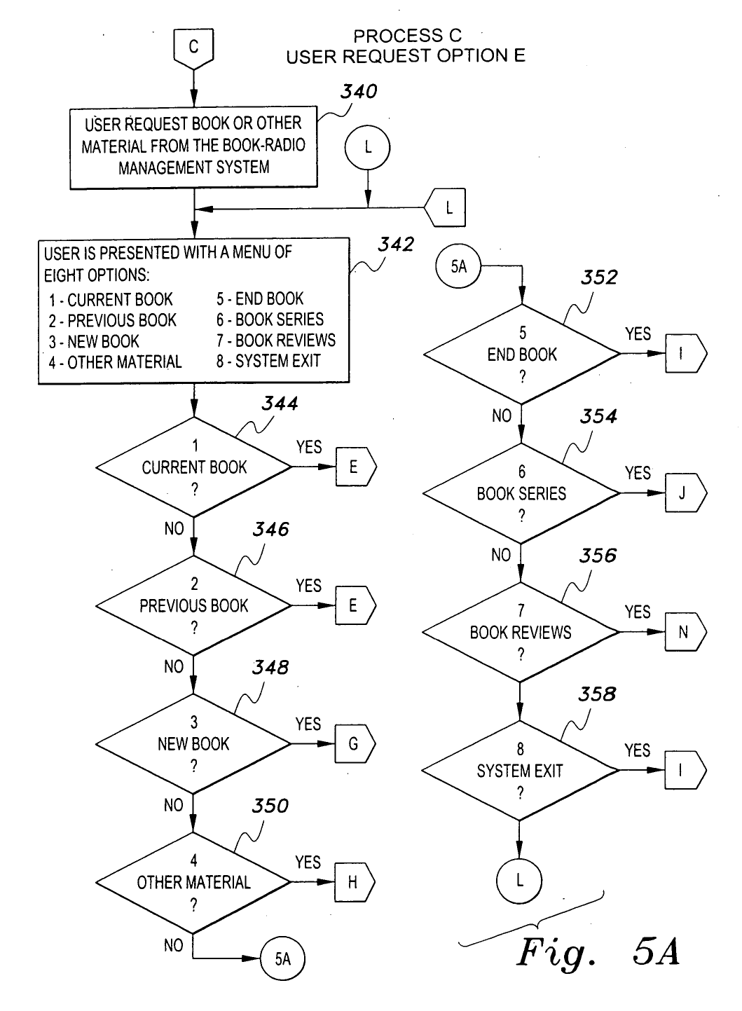

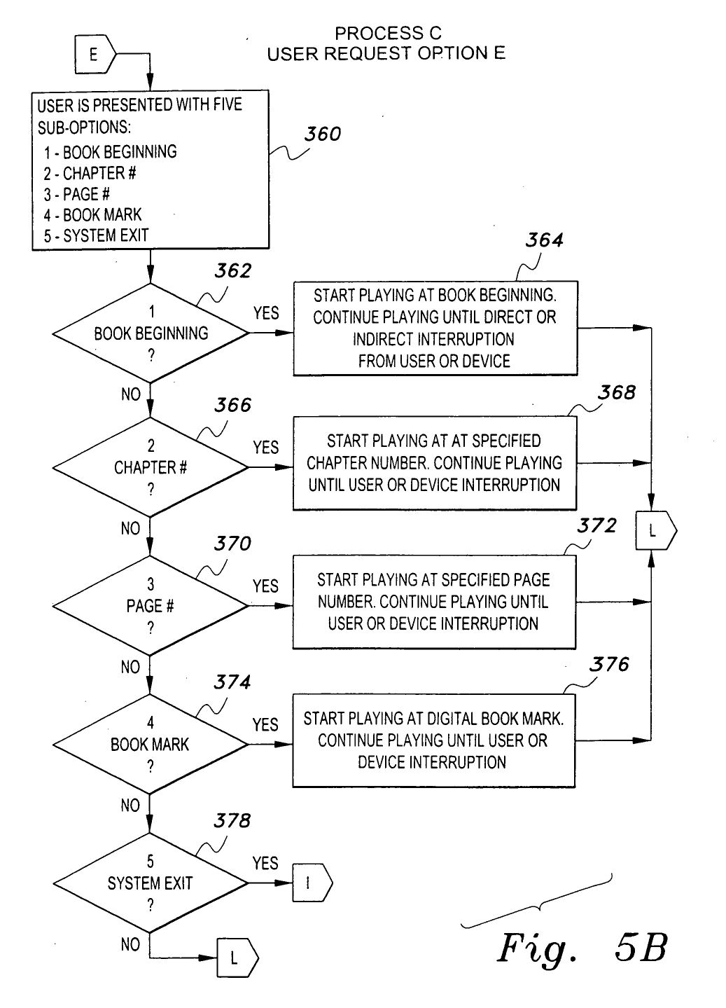

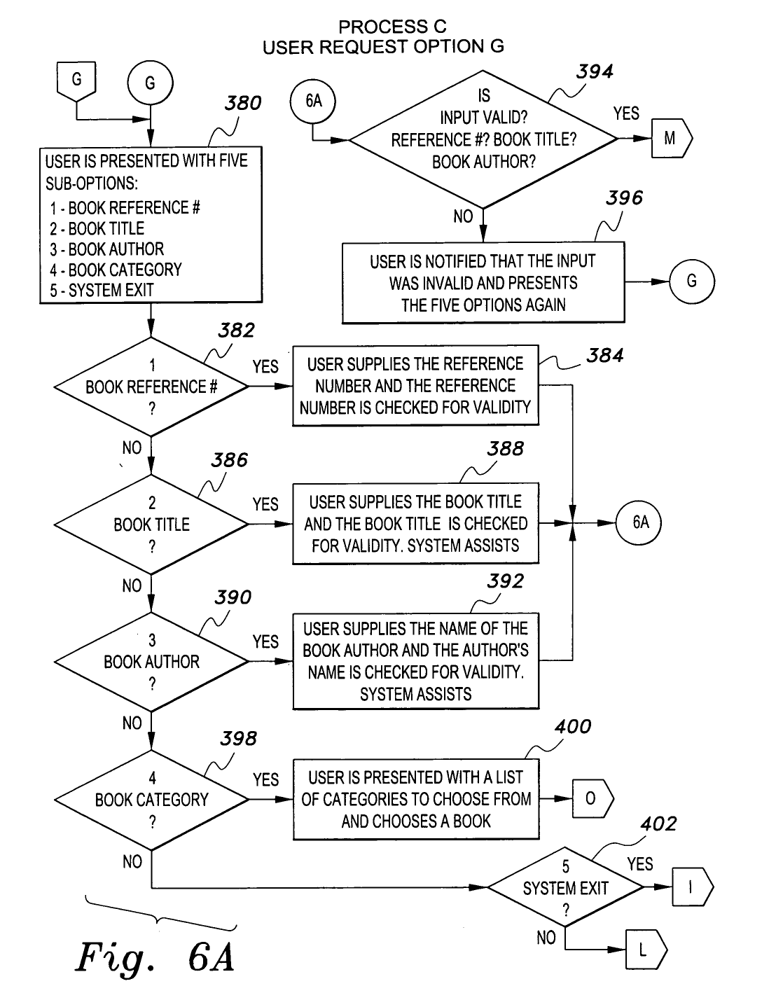

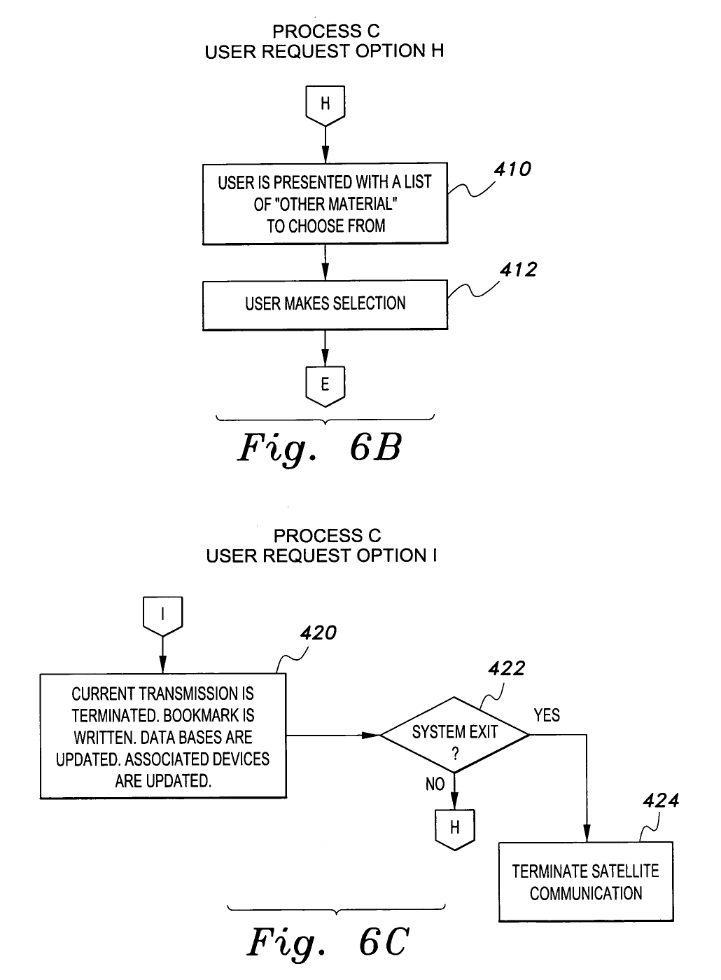

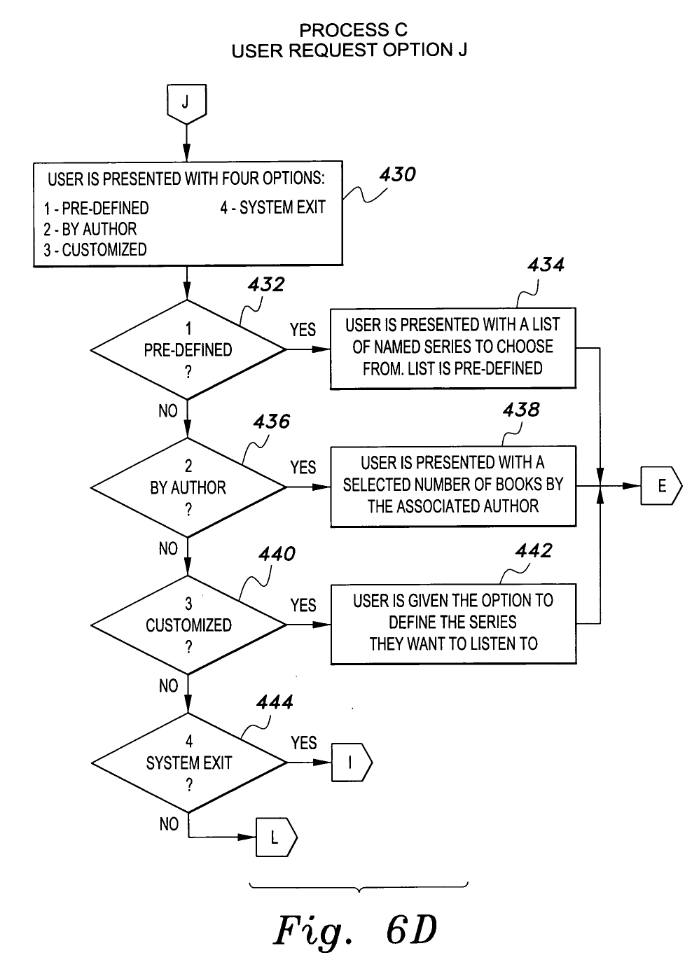

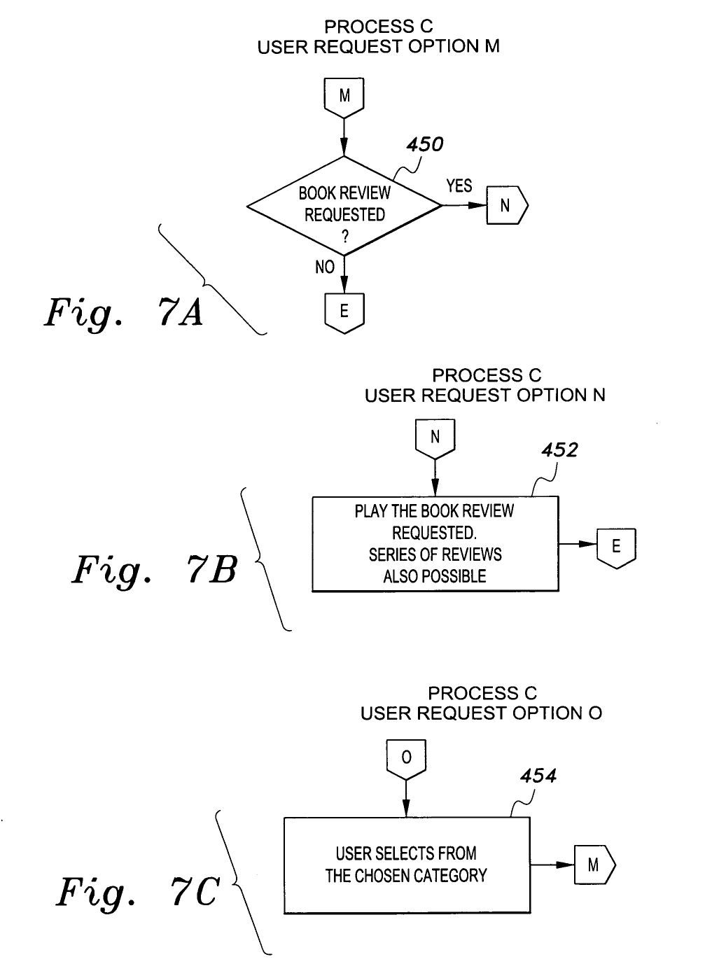

FIG. 4B shows a flow chart of a user/device authentication process, referred to as process B, of BOOK RADIO system 10. A properly configured and equipped BOOK RADIO receiving/playing device 20 is activated 320. The activated BOOK RADIO receiving/playing device 20 communicates to the BOOK RADIO management system via satellite, and a device identification is sent to the BOOK RADIO management system 322. The BOOK RADIO management system requests the user identification and device authentication code that are issued at time of subscription sign-up. The user is given a predetermined number, such as three or the like, of attempts 326 to authenticate the BOOK RADIO receiving/playing device 20. A determination is made of whether authentication is successful 328. If authentication is not successful, the user is given a phone number to call, and may be directed to BOOK RADIO website 30 for authentication failure resolution instructions. If authentication is successful, the user may make a request from BOOK RADIO system 10. FIGS. 5A-7C illustrate various flow charts of user request options when a user is able to make a request from BOOK RADIO system 10.

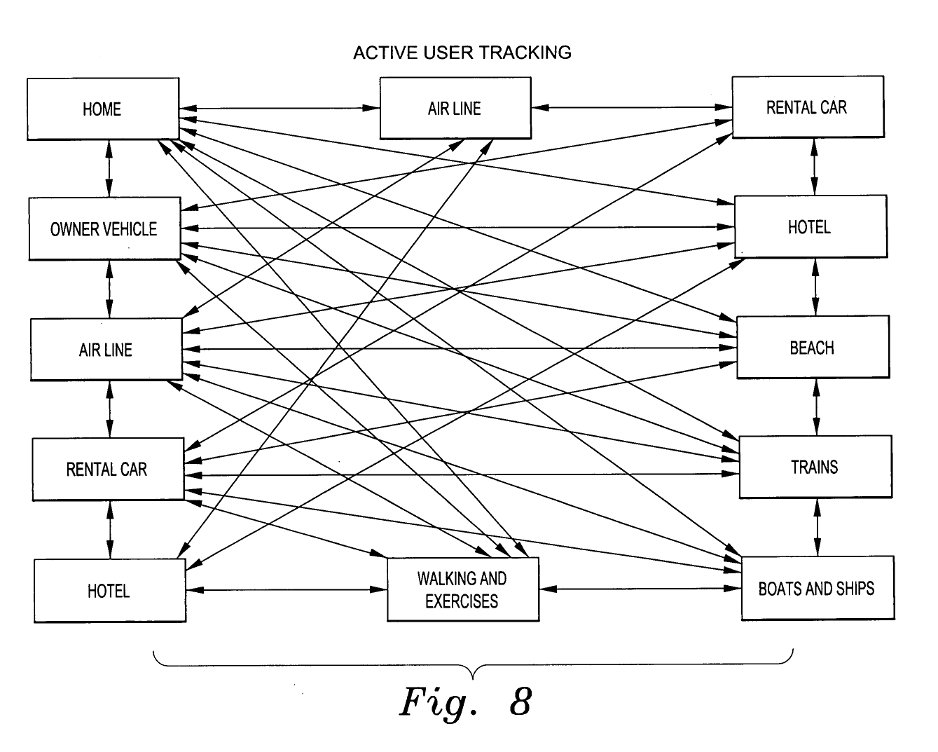

FIG. 8 shows a diagram illustrating how BOOK RADIO system 10 may actively track a user of BOOK RADIO system 10. As users go about their normal lives, BOOK RADIO system 10 enables them to continue listening to their selected material without having possession of tapes, CDs, or Internet access. A user with a BOOK RADIO receiving/playing device 20 may activate the device 20, and begin listening at home to chosen material via BOOK RADIO system 10. Active user tracking allows the listening material of the user to follow them from one properly equipped listening venue to any other properly equipped listening venue. For example, the user may leave home and continue listening to chosen material via BOOK RADIO system 10 in the user's vehicle. The user may then catch a flight to a business meeting and continue listening to chosen material via BOOK RADIO system 10 in flight. The user may then rent a car to get to his/her destination, such as a hotel or the like, where he/she may continue to listen to chosen material via BOOK RADIO system 10.

The user may relax in the hotel and continue to listen to chosen material via BOOK RADIO system 10. The user may then go for a walk and/or exercise while continuing to listen to chosen material via BOOK RADIO system 10. The user may then take a local boat ride after dinner while continuing to listen to chosen material via BOOK RADIO system 10. The user may then take a train ride to get to a client meeting and continue to listen to chosen material via BOOK RADIO system 10. After the meeting the user may then decide to spend some time relaxing on the beach while continuing to listen to chosen material via BOOK RADIO system 10. The user may then return to the hotel and continue to listen to chosen material via BOOK RADIO system 10.

The user may then start the journey home by taking a rental car to an airport while continuing to listen to chosen material via BOOK RADIO system 10. On the flight home the user may continue to listen to chosen material via BOOK RADIO system 10. The user may then land in his/her home airport and take his/her vehicle back home and continue to listen to chosen material via BOOK RADIO system 10. Finally, the user may complete listening to a chosen book or other material via BOOK RADIO system 10 at home. The user may transfer between any combination of properly equipped listening venues as often as desired and maintain listening continuity.

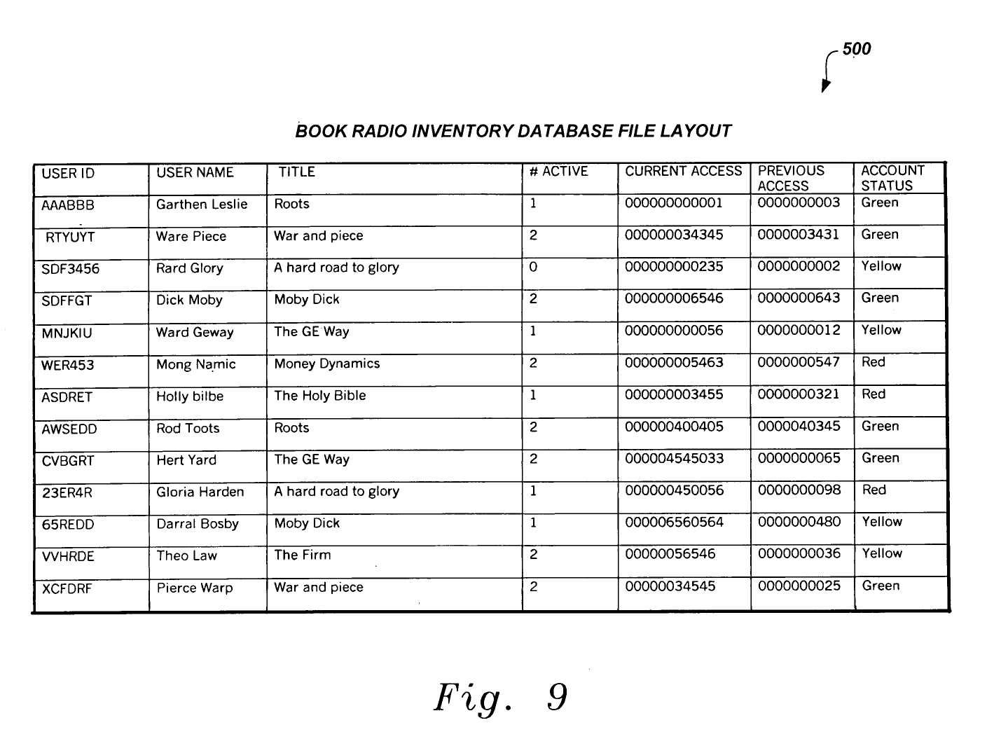

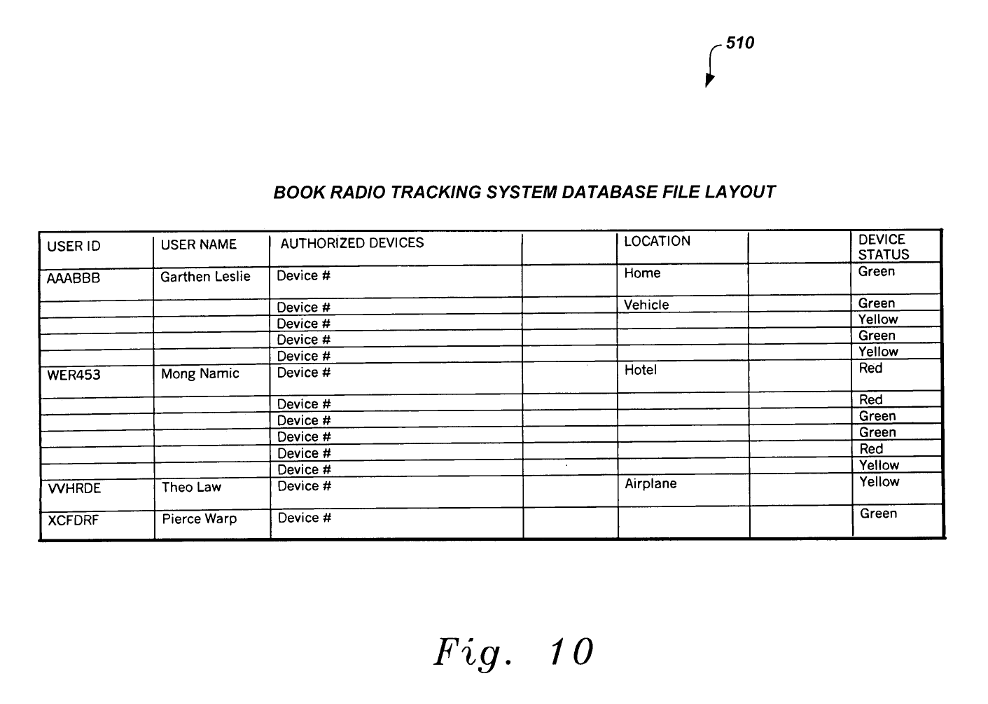

FIG. 9 shows a BOOK RADIO INVENTORY DATABASE file layout of BOOK RADIO system 10. The BOOK RADIO INVENTORY DATABASE 500 includes specific data about any books that are available for transmission, and may be used for generating reports and providing web page content.

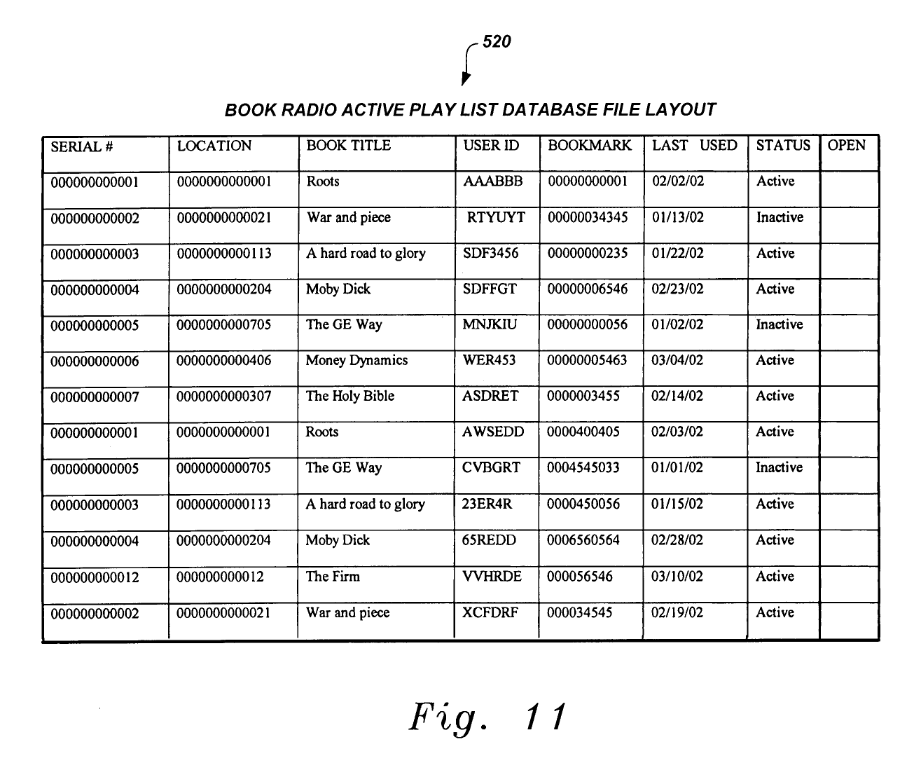

FIG. 10 is a BOOK RADIO TRACKING SYSTEM DATABASE file layout of BOOK RADIO system 10. The BOOK RADIO TRACKING SYSTEM DATABASE 510 includes data regarding most active users and most requested books, statistics on overall user activity and system requests, and may be used for balancing and maintaining high service levels of the BOOK RADIO management system, and/or generating web page content.

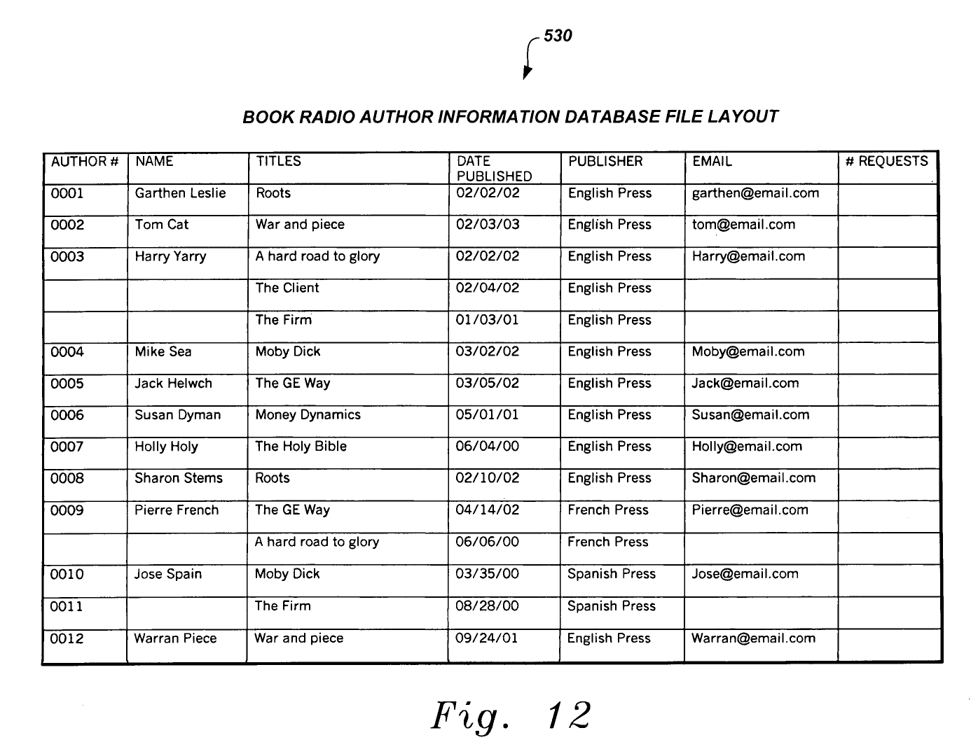

FIG. 11 is a BOOK RADIO ACTIVE PLAY LIST DATABASE file layout of BOOK RADIO system 10. The BOOK RADIO ACTIVE PLAY LIST DATABASE 520 includes data regarding books being read, and may be used for generating reports and statistics on reader activity, providing reader biographical information, and/or generating web page content.

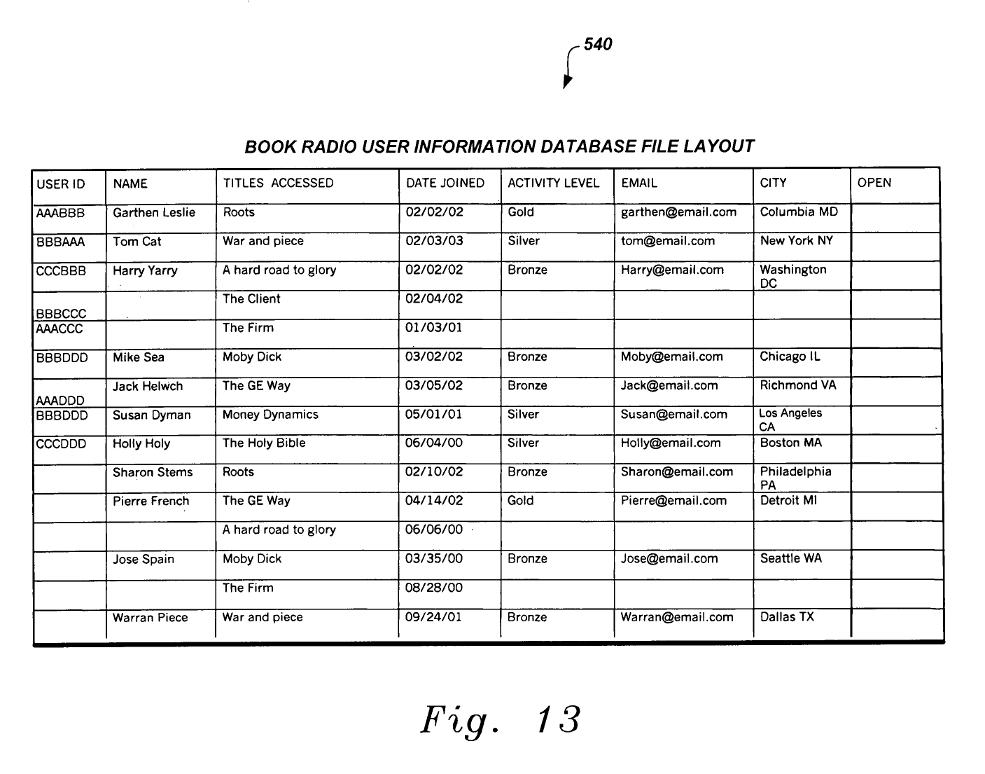

FIG. 12 shows a BOOK RADIO AUTHOR INFORMATION DATABASE file layout of BOOK RADIO system 10. The BOOK RADIO AUTHOR INFORMATION DATABASE 530 includes data regarding titles and other information pertaining to authors, and may be used for generating reports on authors, their books, usage frequency, etc., providing author biographical information, and/or generating web page content.

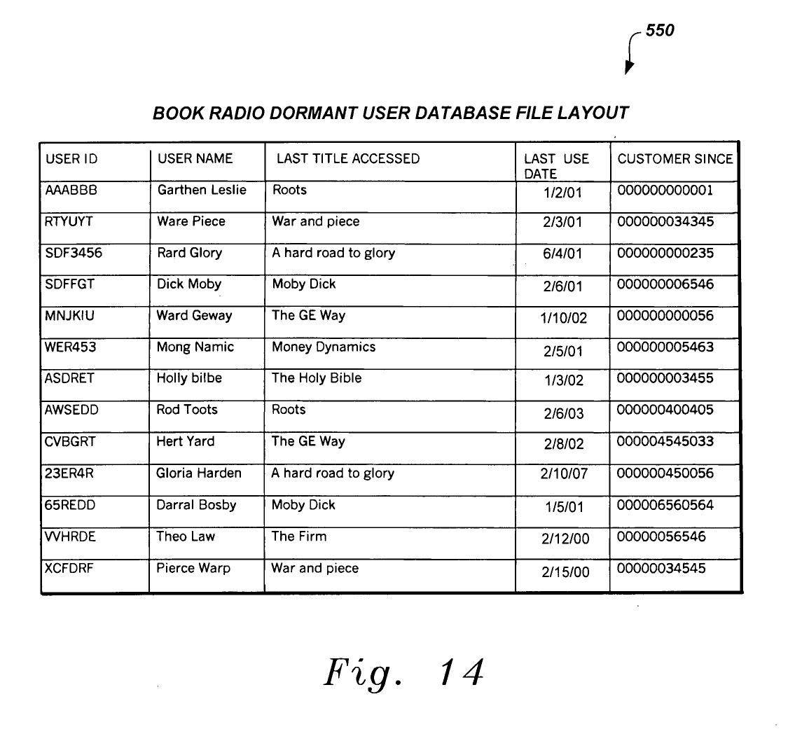

FIG. 13 is a BOOK RADIO USER INFORMATION DATABASE file layout of BOOK RADIO system 10. The BOOK RADIO USER INFORMATION DATABASE 540 includes data regarding requests of users (customers), demographics of users, predetermined user information, and may be used for producing reports on listening habits and book preferences of users, generating thank you notices for users, offering special discounts for long-term users, generating directed marketing campaigns, soliciting inactive users for information about their lack of use of BOOK RADIO system 10, and/or generating web page content.

FIG. 14 is a BOOK RADIO DORMANT USER DATABASE file layout of BOOK RADIO system 10. The BOOK RADIO DORMANT USER DATABASE 550 includes data regarding users that are not active and/or whose subscriptions are not current, and may be used for generating delinquent notices, generating directed marketing campaigns, soliciting inactive users for information about their lack of use of BOOK RADIO system 10, and/or generating web page content.

BOOK RADIO system 10 provides an easy to use mechanism for selecting and listening to pre-read and recorded books, and other pre-read material, such as newspapers, magazine, and speeches, or the like, via properly equipped and configured BOOK RADIO receiving/listening devices 20 in a car, home, or any place during anytime.

Selected books may be read, recorded, serialized and digitized using any efficient digitizing methods, hardware and software available. The digitized data (pre-read book and other selected information) may be stored and serialized for later access. When requested, the digitized and stored book may be transmitted (up linked) to satellite 14 and broadcast to an authorized user. A BOOK RADIO management system (hardware and software) keeps track of which books are requested and who requested them. The authorized user, using BOOK RADIO receiving/playing devices 20 or BOOK RADIO website 30, may make requests for books and other pre-read material, and have the pre-read book delivered to them in real-time with digital satellite quality. Additional information about available books, new BOOK RADIO features, users' reading history, book reviews, book awards, book samples, author information, reader information, book popularity, and/or volume published may be provided.

While the invention has been described with references to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

1. A BOOK RADIO system comprising:
a BOOK RADIO broadcast base station; and
at least one BOOK RADIO receiving/playing device configured to communicatively interconnect with the BOOK RADIO broadcast base station,
wherein the BOOK RADIO system records, serializes, digitizes, stores, and provides BOOK RADIO data from said BOOK RADIO broadcast base station to the at least one BOOK RADIO receiving/playing device when the at least one BOOK RADIO receiving/playing device is communicatively interconnected with the BOOK RADIO broadcast base station.

2. The BOOK RADIO system according to claim 1, wherein the BOOK RADIO system is configured to provide a user of the at least one BOOK RADIO receiving/playing device with a variety of options including a Current Book option, a Previous Book Option, a New Book option, an End Book option, an Other Material option, a Book Series option, a Book Reviews option, and a System Exit option when the at least one BOOK RADIO receiving/playing device is communicatively interconnected with the BOOK RADIO broadcast base station.

3. The BOOK RADIO system according to claim 2, wherein the Current Book option, when selected, is configured to provide the user with a variety of sub options including a Book Beginning sub option, a Chapter Number sub option, a Page Number sub option, a Bookmark sub option, and an End Book sub option.

4. The BOOK RADIO system according to claim 3, wherein the Book Beginning sub option, when selected, is configured to start a selected book at the beginning of the book.

5. The BOOK RADIO system according to claim 3, wherein the Chapter Number sub option, when selected, is configured to start a selected book at a chapter number indicated by the user.

6. The BOOK RADIO system according to claim 3, wherein the Page Number sub option, when selected, is configured to start a selected book at a page designated by the user.

7. The BOOK RADIO system according to claim 3, wherein the Bookmark sub option, when selected, is configured to start a selected book at a digital bookmark generated when the user suspends a previous listening session, or if power is lost to the at least one BOOK RADIO receiving/playing device, and wherein the End Book sub option, when selected, is configured to end transmission of a selected book, generate a digital bookmark, and return the user to a previous option menu.

8. The BOOK RADIO system according to claim 2, wherein the Previous Book option, when selected, is configured to provide the user with a variety of sub options for accessing a previous book selected by the user, the variety of sub options including a Book Beginning sub option, a Chapter Number sub option, a Page Number sub option, and a Bookmark sub option.

9. The BOOK RADIO system according to claim 8, wherein the Book Beginning sub option, when selected, is configured to star a selected book at the beginning of the book.

10. The BOOK RADIO system according to claim 8, wherein the Chapter Number sub option, when selected, is configured to start a selected book at a chapter number indicated by the user, and wherein the Page Number sub option, when selected, is configured to start a selected book at a page designated by the user.

11. The BOOK RADIO system according to claim 8, wherein the Page Number sub option, when selected, is configured to start a selected book at a page designated by the user.

12. The BOOK RADIO system according to claim 8, wherein the Bookmark sub option, when selected, is configured to start a selected book at a digital bookmark generated when the user suspends a previous listening session, or if power is lost to the BOOK RADIO receiving/playing device.

13. The BOOK RADIO system according to claim 2, wherein the New Book option, when selected, is configured to provide user with a variety of sub options including a Book Reference Number sub option, a Book Title sub option, a Book Author sub option, an End Book sub option, and a Book Category sub option.

14. The BOOK RADIO system according to claim 13, wherein the Book Reference Number sub option, when selected, is configured to enable a user to enter a reference number for a particular book, and to have BOOK RADIO system retrieve and present to the user the book associated with the reference number.

15. The BOOK RADIO system according to claim 13, wherein the Book Title sub option, when selected, is configured to enable a user to enter the title of a particular book, and to have BOOK RADIO system retrieve and present to the user the book associated with particular book title entered by the user.

16. The BOOK RADIO system according to claim 13, wherein the Book Author sub option, when selected, is configured to enable a user to enter the name of an author, and to have BOOK RADIO system retrieve and present to the user a predetermined number of books that correspond with the name entered by the user.

17. The BOOK RADIO system according to claim 13, wherein the End Book sub option, when selected, is configured to enable a user to end transmission of a selected book by having the user designate a particular point in the book via a bookmark; and wherein the Book Category sub option, when selected, is configured to enable a user to enter a particular subject category, and to have the BOOK RADIO system retrieve and present a predetermined number of books associated with the particular category entered by the user.

18. The BOOK RADIO system according to claim 2, wherein the Other Material option, when selected, is configured to enable a user to obtain a list of available material categories in alphabetical order with a count of the number of items in each category; and wherein the Book Series option, when selected, is configured to enable a user to select from a predefined series, or to build a series of books.

19. The BOOK RADIO system according to claim 2, wherein the Book Reviews option, when selected, is configured to enable a user to obtain one or more reviews, and wherein the System Exit option, when selected, is configured to enable a user to exit the BOOK RADIO system completely, and to enable the system to record appropriate activity for a listening session, update appropriate files and databases, and return to a neutral state.

20. The BOOK RADIO system according to claim 1, wherein said at least one BOOK RADIO receiving/playing device is configured to operate using voice recognition.
